(19) United States
(12) Patent Application Publication
(10) Pub. No.: US 2022/0076151 A1
(43) Pub. Date: Mar. 10, 2022

(54) COMPUTER-IMPLEMENTED SYSTEM AND METHOD HAVING A DIGITAL TWIN AND A GRAPH-BASED STRUCTURE

(71) Applicant: Robert Bosch GmbH, Stuttgart (DE)

(72) Inventors: Felix Loesch, Stuttgart (DE); Steffen Stadtmueller, Stuttgart (DE)

(21) Appl. No.: 17/446,349

(22) Filed: Aug. 30, 2021

(30) Foreign Application Priority Data
Sep. 4, 2020 (DE) 102020211163.4
Sep. 17, 2020 (DE) 102020211679.2

(51) Int. Cl. G06N 7/00; G06N 5/02; G06F 16/901

(52) U.S. Cl. CPC G06N 7/005; G06F 16/9024; G06N 5/022

(57) ABSTRACT

A computer-implemented system that includes at least one first interface configured to receive and send data from a physical object, and a graph-based structure. The graph-based structure includes a conceptual model including a plurality of concepts, each concept mapping a physical object, the concepts being provided with attributes and their respective relations among one another being defined, and a plurality of data instances that have data points of physical objects and are assigned to the respective concepts in the conceptual model. The graph-based structure receives data from the interface and integrates received data into the conceptual model and/or into the data instances. A user interface provides a query and/or definition to the graph-based structure based on an input of a user and outputs a corresponding response. The computer-implemented system includes at least one digital twin that draws data from the graph-based structure and/or provides data to the graph-based structure.

### CROSS REFERENCE

The present application claims the benefit under 35 U.S.C. § 119 of German Patent Application Nos. DE 102020211163.4 filed on Sep. 4, 2020 and DE 102020211679.2 filed on Sep. 17, 2020, which are both expressly incorporated herein by reference in their entireties.

### FIELD

The present invention relates to a computer-implemented system and to a computer-implemented method for instantiating at least one digital twin.

### BACKGROUND INFORMATION

In industrial environments, there are large quantities of data that can have unstructured formats, representations, and/or heterogenous access methods. These data may be located in data lakes, various databases, and other persistent data structures. In addition, data can be dynamically outputted by machines, sensors, and further devices. In order to make it possible to use and reuse these different, varying, and heterogenous data, there are two promising procedures: a digital twin or a graph-based structure. Both procedures are semantic technologies; the graph-based structure, for example a knowledge graph, raises data themselves to a semantic level, which enables data engineers to answer arbitrary and complex questions by simply querying the graph-based structure. However, graph-based structures are not a reliable data source for applications that require dynamic and repeating data. In contrast, digital twins have the effect that the data themselves remain non-semantic, but are described via associated semantic models. However, the provision of cross-relations between data having different data endpoints by one or more digital twins is difficult. Currently, the two procedures cannot benefit from one another.

### SUMMARY

A first aspect of the present invention relates to a computer-implemented system that includes at least one first interface. In accordance with an example embodiment of the present invention, the interface is configured to receive data from a physical object and to send data. The computer-implemented system additionally includes a graph-based structure that includes a conceptual model and a plurality of data instances. The conceptual model includes a plurality of concepts, each concept mapping a physical object, the concepts being provided with attributes, and their respective relations to one another being defined. The data instances have data points of physical objects, and are assigned to respective concepts in the conceptual model. The graph-based structure is designed to receive data from the interface and is designed to integrate received data into the conceptual model and/or into the data instances. In addition, the computer-implemented system includes a user interface that is designed to provide a query and/or definition to the graph-based structure on the basis of an input from a user, and to output a corresponding response. In addition, the computer-implemented system includes at least one digital twin that is designed to draw data from the graph-based structure and/or to provide data to the graph-based structure.

A second aspect of the present invention relates to a computer-implemented method for instantiating at least one digital twin. In accordance with an example embodiment of the present invention, the method includes the provision of at least one first interface that is configured to receive and to send data from a physical object. In addition, the method includes the provision of a graph-based structure that includes a conceptual model and a plurality of data instances. The conceptual model includes a plurality of concepts, each concept mapping a physical object, the concepts being provided with attributes and their respective relations among one another being defined. The data instances have data points of physical objects and are assigned to respective concepts in the conceptual model. The graph-based structure is designed to receive data from the interface and to integrate received data into the conceptual model and/or into the data instances. In addition, the method includes the provision of a user interface that is designed to provide a query and/or definition to the graph-based structure on the basis of an input from a user, and to output a corresponding response. In addition, the method includes the production of the at least one digital twin, which is designed to draw data from the graph-based structure and/or to provide data to the graph-based structure.

The present invention relates to a system and method that include a graph-based structure and at least one digital twin, which exist independently of one another but can benefit from one another. As a result, the advantages of the two semantic technologies can be combined, and a high degree of automation can be achieved. The graph-based structure can act here as a level for the abstraction and integration of data below it from interfaces that produce for example machine data that are stored in a data lake or database. The at least one digital twin is provided via the graph-based structure, and can draw data from the graph-based structure and/or can provide data to the graph-based structure. On the basis of a query from the at least one digital twin, an application can obtain data having a semantic description, which can simplify the use and reuse of these data.

### BRIEF DESCRIPTION OF THE DRAWINGS

FIG. 1 schematically shows a computer-implemented system 1 having a first interface 10, a graph-based structure 20, a user interface 30, and at least one digital twin 40.

FIG. 2A schematically shows a first segment of a computer-implemented method 100 for instantiating at least one digital twin 40.

FIG. 2B schematically shows a second segment of the computer-implemented method 100 for instantiating at least one digital twin 40.

FIG. 3 schematically shows an example of a computer-implemented method 100 for instantiating at least one digital twin 40.

### DETAILED DESCRIPTION OF EXAMPLE EMBODIMENTS

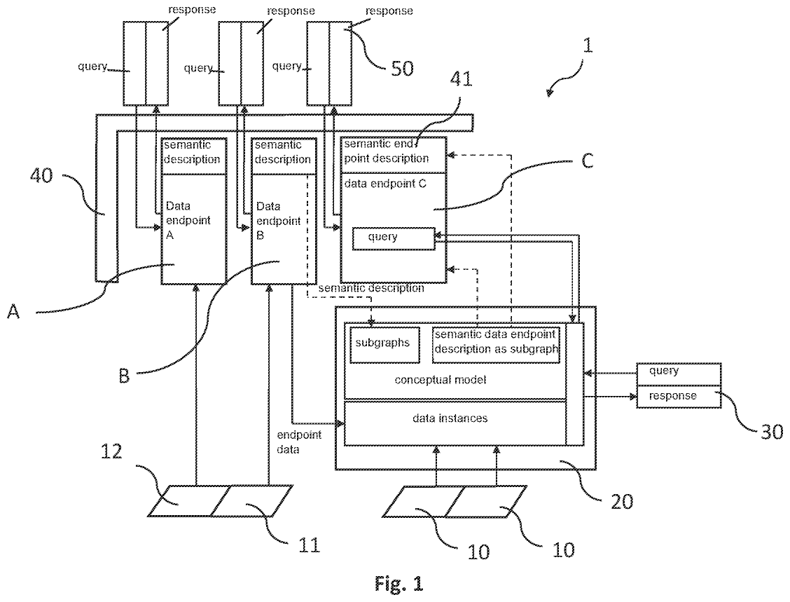

As shown in FIG. 1, a first aspect of the present invention relates to a computer-implemented system 1 that includes at least one first interface 10. The at least one first interface 10 can be, in some embodiments, a sensor interface. The at least one first interface 10 is configured to receive and to send data from a physical object. This physical object can be for example a machine or other technical device M (or a module of a machine or device) that includes sensors that are capable of providing varying, heterogenous, and dynamic data to interface 10. In addition, computer-implemented system 1 includes a graph-based structure (KG) 20 that includes a conceptual model and a plurality of data instances. The graph-based structure can include an ontology (or a plurality of ontologies) which in turn can include the conceptual model and the data instances. An ontology can describe a knowledge domain using a standardized terminology, as well as relations (and, if appropriate, rules of derivation) between the concepts defined there. An ontology can therefore be understood as an explicit formal specification of a conceptualization. The ontology can represent a network of items of information having logical relations. The conceptual model includes a plurality of concepts, each concept mapping a physical object. The concepts are provided with attributes and their respective relations among one another are defined. A concept can be regarded as a node and a relation between the concepts can be regarded as an edge that connects the concepts (or nodes) to one another. The plurality of concepts can be for example a machine M, an installation P, an error code, and/or a product type. The relation between the concepts can be such that for example the machine M produces a particular product type and/or the machine M has an error code. The data instances have data points of physical objects, and are assigned to respective concepts in the conceptual model. The data instances can include various data, for example from machine M. Graph-based structure 20 is designed to receive data from interface 10 and is designed to integrate received data into the conceptual model and/or into the data instances. For example, graph-based structure 20 can receive from the at least one interface 10 a database T_{Machine} that includes all machines M in installation P that can then be mapped in graph-based structure 20 as concepts having relations to one another and attributes, as well as data instances. In addition, computer-implemented system 1 includes a user interface 30 that is designed to provide a query and/or definition to graph-based structure 20 on the basis of a input from a user, and to output a corresponding response. The query and/or definition can be made to the ontology. Via user interface 30, a user can for example query which machine M in installation P defines the most errors for a particular product type. On the basis of graph-based structure 20, a response, with the machine most liable to error, can be outputted. In addition, computer-implemented system 1 includes at least one digital twin 40 that is designed to draw data from graph-based structure 20 and/or to provide data to graph-based structure 20. In this system 1, a digital twin 40 can be combined with a graph-based structure 20. On the basis of graph-based structure 20, heterogenous data from various interfaces can be integrated and abstracted, and graph-based structure 20 can act as a basis for a preparation of data for digital twin 40. Graph-based structure 20 and digital twin 40 can be provided independently of one another, but can benefit from one another. The data of digital twin 40 can be produced on the basis of graph-based structure 10, and can be derived therefrom, thus making it possible to simplify data usage and further processing of data. Through system 1, a high degree of automation can be achieved.

Graph-based structure 20 can include at least one sub-graph that includes concepts and relations that are subsets of graph-based structure 20. For example, the concept “error code” can be connected, by relations, to the concepts (timestamp” and “description (of the error).” If only these three concepts (with their attributes) and their relations are regarded in isolation, then these can be defined as a sub-graph of graph-based structure 20.

The least one first interface 10 can be a data interface. In some embodiments, the at least one first interface 10 can be a sensor interface. The at least one first interface 10 can be linked to at least one already-existing data source. In some embodiments, the at least one first interface 10 can interact with the at least one already-existing data source, in particular such that the at least one first interface 10 can receive and/or send data from the at least one first already-existing data source. The at least one already-existing data source can, in some embodiments, include a data lake and/or a sensor interface and/or a database.

The at least one digital twin 40 may have been produced on the basis of graph-based structure 20, on the basis of a query and/or definition from user interface 32 graph-based structure 20. For example, a user can send a query via user interface 30 to graph-based structure 20 as to which machine M has the most error codes, where, for an application, data of machine M, in particular the error codes, are of interest. Via user interface 30, the user can define, in graph-based structure 20, that there can be a digital twin 40 for a concept, for example for the concept “machine,” representing a relation between the concept (e.g. the concept “machine”) and “digital twin” in the graph-based structure. The system can carry out an automated query via graph-based structure 20 for further concepts that correspond to the concept that was defined as digital twin 40. For these concepts, the system can also produce a respective digital twin, in particular in automated fashion. In another embodiment that can be combined with the embodiment described above, at least one digital twin 40 can be provided independently of graph-based structure 20. However, this digital twin can receive data and/or can provide data to graph-based structure 20.

Digital twin 40 can include a technical device for the physically-based simulation and data analysis of a real physical object in a virtual environment, in particular where the real physical object can be one or more products and/or a production facility. For example, a digital twin of the concept “machine” may include constructive drawings of the machine, sensors of the machine (that generate data), and/or product data of the machine.

The at least one digital twin 40 can include at least one first data endpoint (DEP) C. The at least one first data endpoint C can be produced and derived from graph-based structure 20. Graph-based structure 20 can be used for the integration of heterogenous data that are provided by the at least one first interface 10, and can be used as a basis for producing and deriving the at least one first data endpoint C for the at least one digital twin 40. In addition, the at least one digital twin 40 can include a first semantic model 41, first semantic model 41 being in particular capable of being produced and derived from graph-based structure 20. First semantic model 41 can be adapted to describe the at least one first data endpoint C semantically. A sub-graph of graph-based structure 20 can be projected from graph-based structure 20, and can be assigned to the at least one data endpoint C. The at least one data endpoint C can thus have a semantic description that is derived from graph-based structure 20. An application 50 that accesses the at least one digital twin 40, in particular the at least one first data endpoint C, can thus obtain data having a semantic description, which can simplify data usage and further processing. For example, the sub-graph error code/timestamp/description can be assigned to data endpoint C and derived on the basis of graph-based structure 20. Therefore, for machine M, data can be provided for the error codes, the data of the error code having a corresponding semantic description. Consequently, data endpoints do not have to be able to directly access existing interfaces 10 and/or data sources. Instead of having data endpoints for each existing interface 10 and/or data source (e.g., a sensor interface), graph-based structure 20 can act as a combining level of abstraction between the at least one first interface 10 and the at least one digital twin 40. Thus, a corresponding data endpoint C can draw its data not from the at least one first interface 10 itself, but rather from graph-based structure 20. A produced data endpoint C can output data to an application 50 that can originate from a plurality of interfaces 10 that have been integrated and abstracted via graph-based structure 20.

As described above, graph-based structure 20 can have a plurality of concepts to each of which a digital twin 40 has been respectively assigned. To each of this plurality of digital twins 40, a data endpoint C can be assigned that can be linked to a semantic description derived from a sub-graph from graph-based structure 20. On the basis of a query of system 1, for each digital twin 40 the data of all sub-graphs can be selected and linked to a data endpoint C. Each query to system 1 can be bundled to an individually addressable data endpoint C, and the belonging of each data endpoint to the respective digital twin 40 on the basis of system 1 can be stored.

The at least one digital twin 40 can include at least one second data endpoint B, the at least one second data endpoint B in particular being capable of being produced and derived directly on the basis of data of at least one second interface 11. The at least one second interface 11 can be a data interface. In some embodiments, the at least one second interface 11 can be a sensor interface. The at least one second interface 11 can be linked to at least one already-existing data source. In some embodiments, the at least one second interface 11 can interact with the at least one already-existing data source, the at least one second interface 11 being in particular capable of receiving and/or sending data from the at least one already-existing data source. The at least one already-existing data source can, in some embodiments, include a data lake and/or a sensor interface and/or a database.

The at least one second data endpoint B can have a semantic description that can be produced and derived directly on the basis of data of the at least one second interface 11. For example, the at least one second interface 11 can include data from a warehouse W in installation P. For this warehouse W, a second data endpoint B can be created that receives the data received from interface 11. The received data can then be semantically described manually for second data endpoint B. Graph-based structure 20 can be designed to import data from the at least one second data in point B; in particular, the semantic description of second data endpoint B can be mapped in graph-based structure 20, and the data can be assigned to the data instances. System 1 can combine the data endpoints (e.g., data endpoint C), with the data derived from graph-based structure 20, with “regular” data endpoints (e.g., data endpoint B) that draw data from interfaces that have not been implemented via the graph-based structure. The data of the “regular” endpoints can be integrated into graph-based structure 20 without second interface 11 having been mapped directly in graph-based structure 20.

The at least one digital twin 40 can include at least one third data endpoint A, the at least one third data endpoint A in particular being capable of being produced and derived directly on the basis of data of a third interface 12. The at least one third data endpoint A can be provided independently of first data endpoint C and/or second data endpoint B. The at least one third interface 12 can be a data interface. In some embodiments, the at least one third interface 12 can be a sensor interface. The at least one third interface 12 can be linked to at least one already-existing data source. In some embodiments, the at least one third interface 12 can interact with the at least one already-existing data source; in particular, the at least one third interface 12 can receive and/or send data from the at least one already-existing data source. The at least one already-existing data source can, in some embodiments, include a data lake and/or a sensor interface and/or a database.

In addition, the system can include an application 50 that is designed to obtain, on the basis of a query to the at least one digital twin 40, data having a semantic description, in particular from at least one of the data endpoints A, B, C. This application 50 can be for example computer software that can draw or request data relating to the error code with semantic description from at least one of the data points A, B, C. The at least one digital twin 40 can be designed to provide information about the data endpoints and their semantic descriptions for application 50. The called data from at least one of the data endpoints A, B, C can be further used and/or further processed by application 50 corresponding to their description.

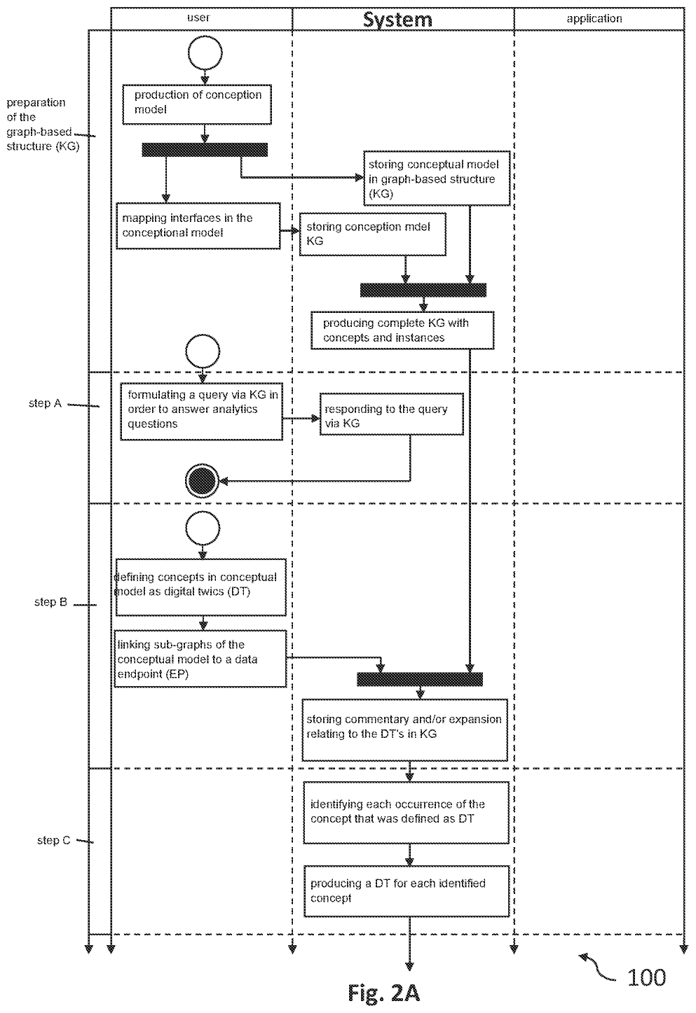

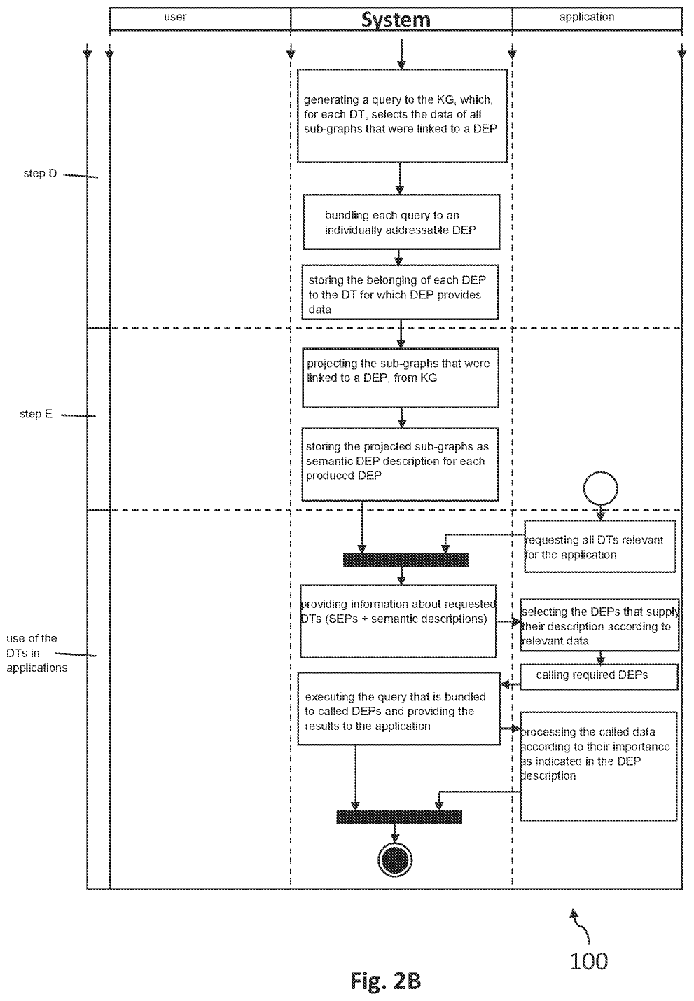

As is shown in FIGS. 2A and 2B, a second aspect relates to a computer-implemented method 100 for instantiating at least one digital twin 40. Method 100 includes the provision of at least one first interface 10 that is configured to receive and to send data from a physical object. In addition, method 100 includes the provision of a graph-based structure (KG) 20 that includes a conceptual model and a plurality of data instances. The conceptual model includes a plurality of concepts, each concept mapping a physical object, the concepts being provided with attributes and their respective relations among one another being defined. First, graph-based structure 20 can be prepared in method 100. The conceptual model of graph-based structure 20 can be produced by a user, the at least one interface, or the data received from interface 10, being capable of being mapped and stored in the conceptual model. The data instances have data points of physical objects and are assigned to respective concepts in the conceptual model. Graph-based structure 20 is designed to receive data from interface 10 and to integrate received data into the conceptual model and/or into the data instances. Method 100 further includes the provision of a user interface 30 that is designed to output a query and/or definition to graph-based structure 20 on the basis of an input from a user, and to output a corresponding response. In a step A of the method, via a user interface 30 the user can send a query to graph-based structure 20 in order to answer one or more analytical questions, and graph-based structure 20 can respond to the analytical questions. Moreover, method 100 includes the production of the at least one digital twin 40, which is designed to draw data from graph-based structure 20 and/or to provide data to graph-based structure 20. Through method 100, a higher degree of automation and an improved use and further use of data can be achieved.

The at least one first interface 10 can be a data interface. In some embodiments, the at least one first interface 10 can be a sensor interface. The at least one first interface 10 can be linked to at least one already-existing data source. In some embodiments, the at least one first interface 10 can interact with the at least one already-existing data source, the at least one first interface 10 in particular being capable of receiving and/or sending data from the at least one first already-existing data source. The at least one already-existing data source can, in some embodiments, include a data lake and/or a sensor interface and/or a database.

In a step B of method 100, the production of the at least one digital twin 40 can include a commenting and/or expansion, in particular by a user, of graph-based structure 20 on the basis of a query and/or definition of user-based interface 32 graph-based structure 20. Graph-based structure 20 can include at least one sub-graph that includes concepts and relations that are subsets of graph-based structure 20. The commenting and/or expansion of graph-based structure 20 can in addition include the defining, in particular by a user, of at least one concept in the conceptual model as digital twin 40, and the linking of the at least one sub-graph in graph-based structure 20 to at least one first data endpoint C on the basis of user interface 30. The commenting and/or expansion can be carried out, in particular by a user, at the conceptual model of graph-based structure 20. In particular, a user can designate concepts of the conceptual model as at least one digital twin 40, and can combine particular sub-graphs with data of the concept and define them as at least one first data endpoint C. In this way, it can be defined which data and concepts are of relevance for applications 50 and/or use cases. The commenting and/or expansion of the concepts in graph-based structure 20 with regard to the at least one digital twin 40 can be stored, in particular by system 1, in graph-based structure 20. Instead of having data endpoints for each existing interface 10, graph-based structure 20 can act as a combining level of abstraction between the at least one first interface 10 and the at least one digital twin 40. A data endpoint thus does not draw its data from the at least one first interface 10 itself, but rather from graph-based structure 20. A produced data endpoint, in particular the at least one first data endpoint C, can output data that can originate from a plurality of interfaces 10 that have been integrated and abstracted via graph-based structure 20.

In a step C of method 100, the production of the at least one digital twin 40 can include the identification of each occurrence of the concept defined as a digital twin in the data received from the at least one first interface 10 in graph-based structure 20. In addition, the production of the at least one digital twin 40 can include the creation of a digital twin 40 for each identified concept. The creation of the at least one digital twin 40 can relate to the production of an entry for at least one digital twin 40 in the system, or to the setting up of an independent application that represents the at least one digital twin 40. This can take place for example via a management shell (e.g. an “asset administration shell”).

The production of the at least one digital twin 40 can in addition include, in a step D of method 100, the automated generation of a query to graph-based structure 20 that, for each digital twin 40, selects the data of all sub-graphs that has been linked to at least one first data endpoint C. Each generated query can be bundled to an individually addressable data endpoint C, and the belonging of each data endpoint C to digital twin 40 for which data endpoint C provides data can be stored. If such an individually addressable data endpoint C is now called by an application 50, then a query can be made to graph-based structure 20, and the defined data of all sub-graphs can be outputted.

Method 100 can in addition include, in a step E, a projection of the sub-graphs that were linked to a data endpoint C from graph-based structure 20, and the storage of the projected sub-graphs as semantic data endpoint description for each produced data endpoint C.

Method 100 can in addition include the use of the at least one digital twin 40 in at least one application 50. Method 100 can here include a provision of an application 50 that can be designed to request all digital twins 40 relevant for application 50 in order to read data out from the respective data endpoints C with a semantic description. Application 50 can first request all digital twins relevant for application 50, or of the at least one digital twin 40, in system 1, the requested digital twins 40 being capable of providing information about data endpoints C and their semantic descriptions. Application 50 can select the data that are relevant according to their semantic description and can call required data endpoints C, or of the at least one first data endpoint C. Application 50 can execute the query, which bundles all called data endpoints C, and can then provide corresponding results to application 50. The use of the at least one digital twin 40 in an application 50 can in addition include the processing of the called data corresponding to their importance according to the semantic description of the at least one first data endpoint C.

Method 100 can in addition include the importing and mapping of data in graph-based structure 20 of at least one second data endpoint B. The at least one second data endpoint B can have a semantic description on the basis of which graph-based structure 20 can be expanded and/or commented. The at least one second data endpoint B can draw data from at least one second interface 11, which provides data independently of graph-based structure 20 for the at least one second data endpoint B. The at least one second interface 11 can be a data interface. In some embodiments, the at least one second interface 11 can be a sensor interface. The at least one second interface 11 can be linked to in particular at least one already-existing data source. In some embodiments, the at least one second interface 11 can interact with the at least one already-existing data source, the at least one second interface 11 in particular being capable of receiving and/or sending data from the at least one already-existing data source. The at least one already-existing data source can, in some embodiments, include a data lake and/or a sensor interface and/or a database. In method 100, the data endpoints (in particular the at least one data endpoint C) can combine with the data derived from graph-based structure 20, with “regular” data endpoints (in particular the at least one second data endpoint B), which draw data from interfaces that have not been implemented or mapped via graph-based structure 20. The data of the “regular” data endpoints can be integrated into the graph-based structure 20 without the second interface 11 having been mapped in graph-based structure 20.

The described system 1 and the described method 100 for instantiating at least one digital twin 40 can include a computer or a network of computers, or can be executed via these, the computer or the network of computers including at least one processor and at least one memory. The described method logic can be stored in the form of executable code in at least one memory and executed by the at least one processor. The at least one first, second, and/or third interfaces 10, 11, 12 and/or the graph-based structure 20 and/or user interface 30 and/or the at least one digital twin 40 and/or application 50 can send data to the at least one processor, and optionally can also receive instructions from the at least one processor. Here, the processor can direct queries that are initiated by a user and/or automatically generated to system 1. Computer-implemented system 1 is not limited to a particular hardware environment. Thus, the techniques described herein can be carried out by devices that are distributed and coupled via a network. The disclosure also includes electrical signals and computer-readable media that define commands that, when they are carried out by a processor, implement the techniques described herein.

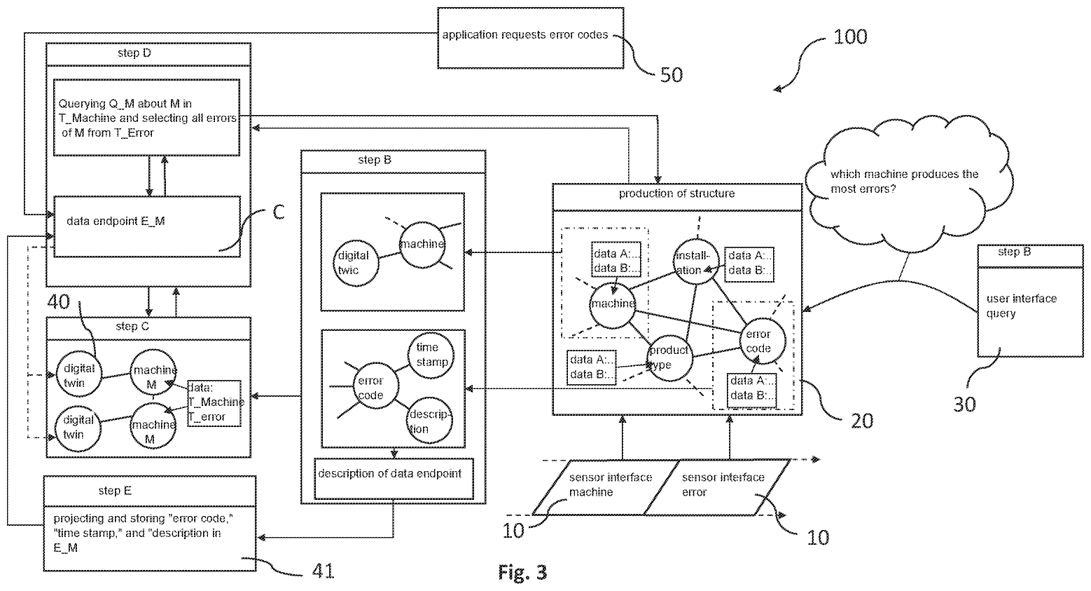

FIG. 3 shows an example of method 100 for instantiating at least one digital twin 40 that can take place using system 1. In the example, at first the conceptual model can be created by a user, as part of graph-based structure 20. As described above, the concepts “machine,” “installation,” “error code,” and “product type” can first be mapped by a user in the conceptual model as part of graph-based structure 20, linked to one another via relations, and provided with attributes. The created concepts can be based here on the mapping of corresponding interfaces 10 that are present, in particular sensor interfaces, such as the sensor interface “machine” and/or the sensor interface “error” shown in FIG. 3. Data instances that are based on data of the at least one interface 10 can be assigned to the respective concepts. After the creation of the graph-based structure in step A, a user can direct the query “which machine in the installation produces, on average, the most errors during the production of a product type K?” to graph-based structure 20 via a user interface 30. System 1, in particular graph-based structure 20, can identify the machine that is most susceptible to error in the production of a product, and a user could decide to develop a monitoring software and to configure it to monitor the machine. Such a software can repeatedly query this machine for newly occurring errors, in order to issue a warning or to support a user during production. This software can be regarded as application 50.

For the user, according to the query the concepts “machine” and “error code” may be important for application 50. As shown in step B, the user can expand graph-based structure 20 with the concept “digital twin,” and can define a relation with the concept “machine.” In addition, the user can define that the concept “error code” and all concepts connected immediately to this concept, such as the concept (timestamp” and the concept “description,” represent a sub-graph, and can define these as description for a data endpoint C of digital twin 40. A database that originates from an interface 10, in particular a sensor interface, mapped on graph-based structure 20, and that can be assigned to the data instances in graph-based structure 20 can have a table T_{Machine} that contains all machines M in installation P. As shown in step C, system 1 can make an automatically generated query for each machine M in T_{Machine}, and can in each case produce a digital twin DT_{M}. A further data instance can have a table T_{Error} that can store each error of each machine M in installation P, and can also contain associated information, such as the timestamp and the description. Both tables, T_{Machine} and T_{Error}, have been assigned to respective concepts in the graph-based structure. In step D, system 1 can produce a query Q_{M} for each machine M in the table T_{Machine}, so that the query can select all errors of M from T_{Error} and the items of information “timestamp” and “description” connected therewith. System 1 can now create a data endpoint E_{M}. Calling data endpoint E_{M} can bring about a query Q_{M} via graph-based structure 20, and can output the occurrent errors of machine M. System 1 can link this at least one first data endpoint C with the digital twin DT_{M}.

As described above, the concepts “error code,” “timestamp,” and “description” can represent a sub-graph of graph-based structure 20, and were linked in step B to a data endpoint description. This sub-graph can be projected from graph-based structure 20 and can be assigned to data endpoint E_{M}, whereby E_{M} is linked to a semantic description. Application 50, for example the monitoring software, can read out the errors of each machine M with an associated semantic description.

What is claimed is:

1. A computer-implemented system, comprising:
at least one first interface configured to receive and to send data from a physical object;
a graph-based structure, including:
a conceptual model that includes a plurality of concepts, each concept mapping a physical object, the concepts being provided with attributes, and their respective relations among one another being defined, and
a plurality of data instances that have data points of physical objects and are assigned to the respective concepts in the conceptual model,
the graph-based structure being configured to receive data from the interface and being configured to integrate received data into the conceptual model and/or into the data instances;
a user interface configured to provide a query and/or definition to the graph-based structure based on an input of a user and to output a corresponding response; and
at least one digital twin that is configured to draw data from the graph-based structure and/or to provide data to the graph-based structure.

2. The computer-implemented system as recited in claim 1, wherein the at least one first interface is linked to at least one already-existing data source and/or interacts with the at least one already-existing data source, the at least one first interface being a sensor interface.

3. The computer-implemented system as recited in claim 1, wherein the at least one digital twin is produced based on the graph-based structure, based on a query and/or definition of the user interface to the graph-based structure.

4. The computer-implemented system as recited in claim 1, wherein the digital twin includes a technical device for physically-based simulation and data analysis of a real physical object in a virtual environment, the real physical object being one or more products and/or a production installation.

5. The computer-implemented system as recited in claim 1, wherein the at least one digital twin includes at least one first data endpoint, the at least one data endpoint being produced and derived from the graph-based structure.

6. The computer-implemented system as recited in claim 5, wherein the at least one digital twin includes a first semantic model, the first semantic model being produced and derived from the graph-based structure.

7. The computer-implemented system as recited in claim 6, wherein the first semantic model is adapted to semantically describe the at least one first data endpoint.

8. The computer-implemented system as recited in claim 1, wherein the digital twin includes at least one second data endpoint, the at least one second data endpoint being produced and derived directly based on data of a second interface, the second interface being a second sensor interface.

9. The computer-implemented system as recited in claim 8, wherein the at least one second data endpoint has a semantic description that is produced and derived directly based on data of the second interface.

10. The computer-implemented system as recited in claim 9, wherein the graph-based structure is configured to import data from the at least one second data endpoint, the semantic description of the second data endpoint being mapped in the graph-based structure and the data being assigned to the data instances.

11. The computer-implemented system as recited in claim 1, wherein the digital twin includes at least one third data endpoint, the at least one third data endpoint being produced and derived directly based on data of a third interface, the third interface being a third sensor interface.

12. The computer-implemented system as recited in claim 10, further comprising an application that is configured to obtain, based on a query to the at least one digital twin, data from at least one of the data endpoints with a semantic description.

13. A computer-implemented method for instantiating at least one digital twin, comprising the following steps:
a) providing at least one first interface configured to receive and to send data from a physical object;
b) providing a graph-based structure, including:
a conceptual model that includes a plurality of concepts, each concept mapping a physical object, the concepts being provided with attributes and their respective relations among one another being defined, and
a plurality of data instances that have data points of physical objects and are assigned to the respective concepts in the conceptual model;
the graph-based structure being configured to receive data from the interface and to integrate received data into the conceptual model and/or into the data instances; and
c) providing a user interface configured to provide a query and/or definition to the graph-based structure based on an input of a user and configured to output a corresponding response; and
d) producing the at least one digital twin, which is configured to draw data from the graph-based structure and/or to provide data to the graph-based structure.

14. The computer-implemented method as recited in claim 13, wherein the at least one first interface is linked to at least one already-existing data source and/or interacts with the at least one already-existing data source, and wherein the at least one first interface is a sensor interface.

15. The computer-implemented method as recited in claim 13, wherein the producing of the at least one digital twin further includes:
commenting and/or expanding the graph-based structure based on a query and/or definition of the user interface to the graph-based structure.

16. The computer-implemented method as recited in claim 15, wherein the graph-based structure includes at least one sub-graph that includes concepts and relations that are subsets of the graph-based structure.

17. The computer-implemented method as recited in claim 16, wherein the commenting and/or expanding of the graph-based structure further includes:
defining at least one concept in the conceptual model as digital twin and linking the at least one sub-graph in the graph-based structure to at least one first data endpoint based on the user interface.

18. The computer-implemented method as recited in claim 17, wherein the producing of the at least one digital twin further includes:
identifying each occurrence of the concept defined as digital twin in data received from the interface in the graph-based structure and creating a digital twin for each identified concept.

19. The computer-implemented method as recited in claim 17, wherein the producing of the at least one digital twin further includes:
automatedly generating a query to the graph-based structure, which, for each digital twin, selects data of all sub-graphs that were linked to at least one first data endpoint.

20. The computer-implemented method as recited in claim 19, wherein each generated query is bundled to an individually addressable data endpoint, and a belonging of each data endpoint to the digital twin for which data is provided to the at least one first data endpoint being stored.

21. The computer-implemented method as recited in claim 19, further comprising:
projecting the sub-graphs that were linked to at least one first data endpoint from the graph-based structure and storing the projected sub-graphs as semantic data endpoint description for each produced data endpoint.

22. The computer-implemented method as recited in claim 20, further comprising:
providing an application configured to request all digital twins relevant for the application in order to read out data from the individually addressable data endpoint with a semantic description.
